(19) United States
(12) Patent Application Publication
(10) Pub. No.: US 2003/0141734 A1
(43) Pub. Date: Jul. 31, 2003

(54) Drive mechanism unit for moving a cover in an motor vehicle

(76) Inventor: Horst Schmidt, Stuttgart (DE)

Correspondence Address: WALTER A. HACKLER, 2372 S.E. BRISTOL, SUITE B, NEWPORT BEACH, CA, 92660-0755, US

(21) Appl. No.: 10/354,506

(22) Filed: Jan. 29, 2003

(30) Foreign Application Priority Data
Jan. 31, 2002 (DE) 102 03 743.4

(51) Int. Cl. B60R 7/00

(52) U.S. Cl. 296/37.1

(57) ABSTRACT

An arrangement consists of a drive mechanism unit (1) for moving a cover (9) in an motor vehicle, wherein the drive mechanism unit (1) comprises a motor (2) for moving at least one drive element (7) connected with the cover (9). The drive mechanism unit (1) or at least parts of the drive mechanism unit (1) are disposed in the region of the vehicle roof or on the vehicle roof. The at least one drive element is mounted or housed in or on the D-column or another body part. The space required for installation was kept to a minimum. The drive is such that the cover (9) is extended and retracted uniformly. Mounting is quick and simple.

The present invention concerns a drive mechanism unit for moving a cover in an motor vehicle. The cover may be rigid, folded or, for a covering blind, rolled to be extendable or retractable.

A cover serves to block the view into the trunk. The cover additionally has a safety function since the cover may retain objects in the trunk in case of an accident.

A covering blind known per se substantially consists of a winding shaft and a cover which can be wound onto the winding shaft by means of a spring means. The cover can be extended or retracted to cover parts of a trunk, loading space or other regions of a vehicle.

A station wagon has no permanent, stationarily mounted rigid cover or limit of the trunk such that the trunk can have a variable design and permit optimum loading of the vehicle.

In a similar fashion, covers are used also for coupe convertible cars with foldable metal roof. The vehicle roof which consists of several parts in these vehicles, can be automatically folded and stored in the trunk. A cover which subdivides the trunk must be drawn out before opening the vehicle roof. The drawn-out cover marks the available useful space of the trunk so that the user does not put any luggage in the region of the trunk which is required later by the folded vehicle roof. It shall be prevented that the vehicle roof squashes the luggage when the roof is introduced into the trunk or that the mechanism for moving the vehicle roof is damaged. The extended state of the cover can be monitored with an electric contact or a sensor to start motor-driven opening of the roof only when the cover has been extended.

Covers are also used as sun protection on the windows of the vehicle. The cover must be extended and retracted also in this case.

For this reason, the invention can be used anywhere in the vehicle where defined movement of a cover is required.

Manually operable covering blinds are known from practice for station wagons. A motor-driven covering blind is disclosed e.g. in DE 195 39 848 A1.

The realization of electromotive drive mechanisms for covers in a vehicle poses in general the following technical problems: The space required for installation shall be as small as possible. The drive must be designed such that the cover is uniformly moved or extended or retracted. Mounting shall be quick and simple.

These problems are solved by a drive mechanism unit in accordance with claim 1. The arrangement of the motor or the drive mechanism unit in the region of the vehicle roof or on the vehicle roof or inner roof and arrangement of the at least one drive element for deflecting the cover simplifies mounting and supports reproducible drive.

The cover may be deflected through two simple different drive mechanism units. A drive mechanism unit may comprise a motor for driving a flexible shaft and a gearing for converting rotation of the shaft into translation of a drive element connected with the carrier wherein the carrier is provided for deflecting the cover. A drive mechanism unit may also comprise a motor and at least one worm gearing for translational motion of the at least one drive element.

In a preferred realization of the gearing of the first drive mechanism unit, the gearing has a driven gear wheel for engagement in an outer profile of the shaft.

The drive elements for moving the carrier may have different designs. The drive elements for reciprocating motion of the carrier may be formed by a flexible shaft, wherein the surface of the flexible shaft has a profile into which the toothing of the driven gear wheel engages. On the other hand, the drive elements may be formed for deflecting the carrier through a deflected toothed belt which can be driven via the driven gear wheel. It is also feasible that the drive element is designed for reciprocating motion of the carrier through cable control or tension which can be wound via the driven gear wheel and is connected with the cover via the carrier.

A return spring may be provided whose spring force counteracts the winding process of the cable control. The cover is automatically withdrawn into its initial position when the cable tension decreases. The return spring can be designed as tension or pressure spring depending on the arrangement of the cable control.

In accordance with the invention, the carrier is always connected to the drive element such that the carrier is displaced through actuation of the drive element. The carrier can be designed in different alternative shapes, i.e. as step, hook, slider, stop etc.

The invention is explained in more detail in the following description with reference to schematic illustrations of two embodiments.

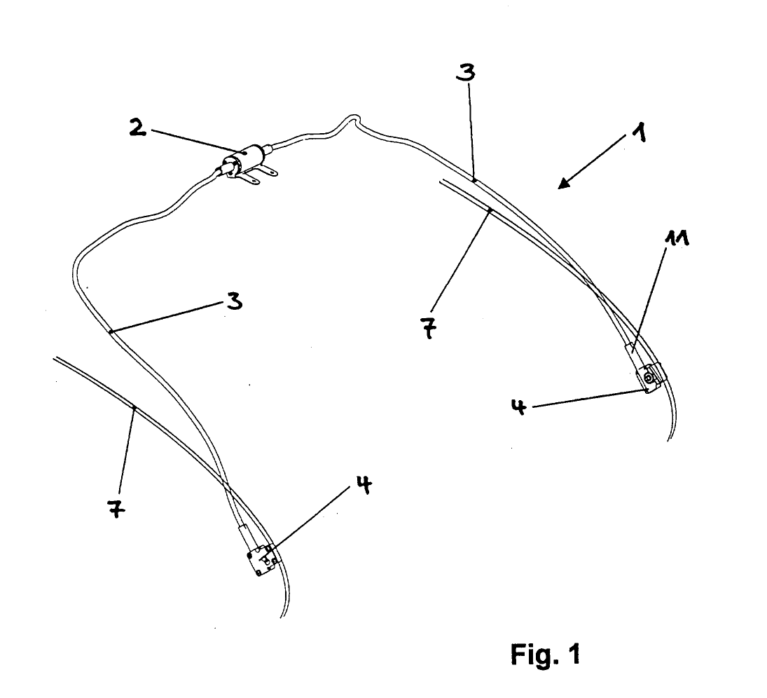

FIG. 1 shows a perspective view of essential parts of a first drive mechanism unit of a covering blind;

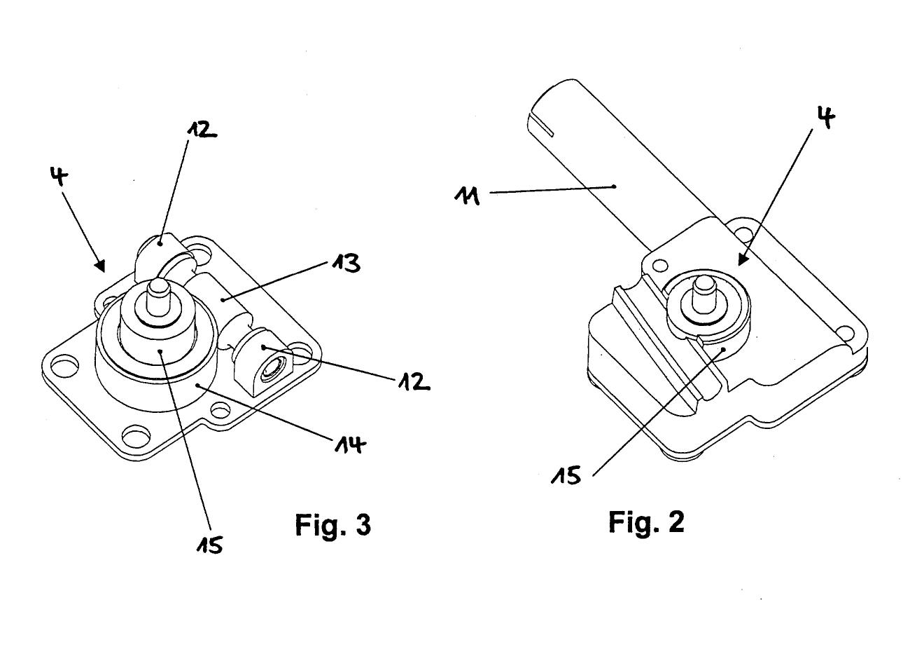

FIG. 2 shows a perspective view of a gearing of the first drive mechanism unit;

FIG. 3 shows a perspective view of a gearing of FIG. 2 after removal of the housing;

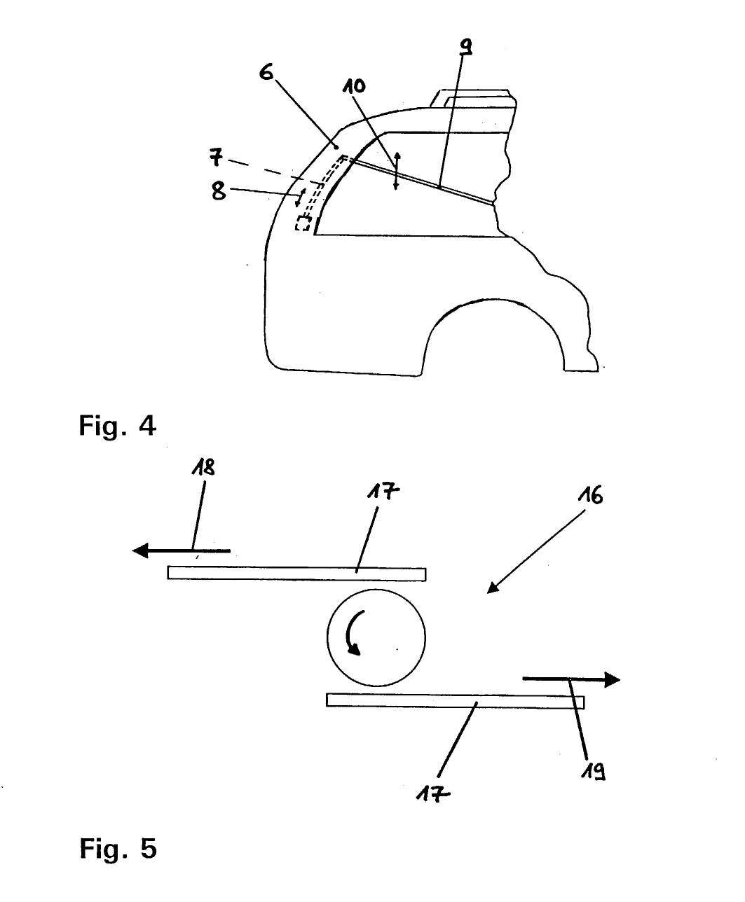

FIG. 4 shows the function of the drive mechanism unit of FIG. 1;

FIG. 5 shows the function principle of a second drive mechanism unit.

FIG. 1 shows that a drive mechanism unit 1 for moving a cover (not shown in FIG. 1) of a covering blind comprises an electromotor 2, two flexible shafts 3 (one for the left and one for the right side of the cover) and two gearings 4 associated with one shaft 3 each.

The cover can be wound onto a winding shaft by means of a spring means and can be extended and retracted. The spring means automatically retracts the cover. The embodiment shows a drive mechanism unit for the cover of a trunk of a station wagon.

The electromotor 2 or the drive mechanism unit 1 may be mounted to the vehicle roof or to other body regions, such as e.g. in the region of the D-column of the station wagon through fixing elements 5. The electromotor 2 drives the flexible shafts 3.

FIG. 4 shows the function of this drive mechanism. The flexible shafts (not shown in FIG. 4) of plastic or metal are accommodated on both sides each in a groove in a left and a right D-column 6 of a vehicle. Rotation of the flexible shafts is converted via the gearing 4 into a translational motion of the drive elements (shaft 7) disposed on both sides which are also movably disposed in a guiding rail in the D-column 6. The double arrow 8 shows clearly the translation of the drive elements 7. Each motion of a drive element 7 produces deflection of a carrier. The carrier may be rigidly mounted or movably positioned on an end of the drive element 7 facing away from the gearing 4. The carrier cooperates with the preferably reinforced end of a cover 9. For this reason, translation of the drive elements 7 and hence of the carrier may cause lifting of the cover 9 in a vertical direction 10 towards the vehicle roof.

One end of the flexible shaft 3 is connected to the electromotor 2 and the other end is connected to the gearing 4. In accordance with FIGS. 2 and 3, the flexible shaft 3 introduced into a coupling 11 initially drives a worm 13 which is fixed in bearing shells 12 and whose motion is again transferred via a worm wheel 14 to a driven gear wheel 15. The surface of the drive elements 7 formed by a shaft is designed (toothing between grooves or profiles of the drive element 7 with teeth of the driven gear wheel 15) such that rotation of the driven gear wheel 15 is converted into a translation of the drive element 7.

The mechanical components of the drive shown in the figures can be combined with electrical contacts or sensors such that the state of the cover 9 is monitored and e.g. the cover is automatically lifted during opening of the rear flap. An operating switch may be mounted in the inside of the vehicle to lift the cover.

Although numerous combinations and operating mechanisms are possible, the following application will be standard: Initially, the cover is extended to a stop point in the region of the D-column and secured (closed position). When the rear flap is opened, the carrier moves upwards and deflects the cover in the direction of the vehicle roof from the originally horizontal cover level. The cover reaches a loading position for loading and unloading the trunk. If the rear flap is subsequently closed again, the drive element moves back, carrying along the cover and pushes the cover into the closed position. A final switch switches off the drive. Operating of the rear flap includes automatic lifting and lowering.

As an alternative to the first drive mechanism unit, a second drive mechanism unit 16 of FIG. 5 comprises a geared motor. Rotation of a driven gear wheel of the geared motor transfers a first and second drive element 17 (only indicated in FIG. 5) (one for the left and one for the right side of the cover) into a translation in the translation direction 18 and 19 such that a cover connected to the drive elements 17 can be extended or retracted. The drive elements 17 may be rigid and also flexible e.g. as displacable shafts.

### List of Reference Numerals

1 drive mechanism unit

2 electromotor

3 shaft

4 gearing

5 fastening element

6 D-column

7 drive element

8 double arrow

9 cover

10 direction of motion

11 coupling

12 bearing shell

13 worm

14 worm wheel

15 driven gear wheel

16 drive mechanism unit

17 drive element

18 translation direction

19 translation direction

1. Arrangement consisting of a drive mechanism unit (1; 16) for moving a cover (9) in an motor vehicle, wherein the drive mechanism unit (1; 16) comprises a motor (2) for moving at least one drive element (7; 17) connected with the cover (9), characterized in that the drive mechanism unit (1; 16) or at least parts of the drive mechanism unit (1; 16), e.g. the motor (2), are mounted or accommodated in the region of the vehicle roof or inner roof and the at least one drive element is mounted or accommodated in or on the D-column or another body region.

2. Arrangement according to claim 1, characterized in that the drive mechanism unit (1) comprises the motor (2) for driving a flexible shaft (3) and a gearing (4) for converting rotation of the shaft (3) into translation of a drive element (7) connected to a carrier, wherein the carrier is provided for deflecting the cover (9).

3. Arrangement according to claim 2, characterized in that the gearing (4) comprises a driven gear wheel (15) for engagement in an outer profile of the flexible shaft (3).

4. Arrangement according to claim 1, characterized in that the drive mechanism unit (16) comprises a motor and at least one worm gear for translational motion of the at least one drive element (17).

5. Arrangement according to claim 1, characterized in that the at least one drive element (7; 17) is formed by a flexible shaft whose surface is profiled.

6. Arrangement according to claim 1, characterized in that the at least one drive element (7; 17) is formed by a tension element.

7. Arrangement according to claim 6, characterized in that the tension element is formed by a toothed belt.

8. Arrangement according to claim 6, characterized in that the tension element is formed by cable control.

9. Arrangement according to claim 8, characterized in that a return spring is provided whose spring force counteracts the winding process of the cable control.
